(19) United States
(12) Patent Application Publication
(10) Pub. No.: US 2007/0252405 A1
(43) Pub. Date: Nov. 1, 2007

(54) Convertible car seal structure

(76) Inventor: Sadashige Uno, Hiroshima (JP)

Correspondence Address: FLYNN THIEL BOUTELL & TANIS, P.C., 2026 RAMBLING ROAD, KALAMAZOO, MI, 49008-1631, US

(21) Appl. No.: 11/789,973

(22) Filed: Apr. 26, 2007

(30) Foreign Application Priority Data
Apr. 27, 2006 (JP) 2006-122836

(51) Int. Cl. B60J 7/00

(52) U.S. Cl. 296/107.04

(57) ABSTRACT

A seal structure for a convertible car having front and rear roofs separately turned and opened/closed, comprising a roof side weatherstrip attached to the front roof side and an open weatherstrip attached to the front edge of the rear roof, wherein a contacting surface tilted or curved downward in the front is formed at the molded part of the open weatherstrip that is attached to the corners of the rear roof, a contacted surface tilted or curved upward in the back is formed at the molded part at the rear end of the roof side weatherstrip, and these surfaces are contacted together for sealing when the rear roof is closed.

### CROSS-REFERENCE TO THE RELATED ART

This application incorporates by reference the subject matter of Application No. 2006-122836, filed in Japan on Apr. 27, 2006, on which a priority claim is based under 35 U.S.C. §119 (a).

### BACKGROUND OF THE INVENTION

1. Field of the Invention

The present invention relates to a seal structure for a convertible car having front and rear roofs separately opened/closed that provides sealing between the front and rear roofs when they are closed.

2. Description of the Related Art

As shown in FIG. 1, some convertible cars have a fixed rear roof 2 along with a back window 1 and a fixed glass 4 and a detachable front roof 3. Such convertible cars are generally provided with weatherstrip 5 along the front edge of the rear roof 2, the fixed glass 4 and a roof side weatherstrip 6 along the roof side of the front roof 3. Among these, the weatherstrip 5 makes elastic contact with the rear edge of the front roof 3 and window glass 7 to provide sealing against the front roof 3 and window glass 7. The roof side weatherstrip 6 makes elastic contact with the top edge of the window glass 7 to provide sealing against the window glass 7. The weatherstrip 5 comprises a molded part 8 shown in FIG. 2 in the corner portion a in FIG. 1. The molded part 8 is connected to an extrusion 16 having a pair of bulb parts 15 that form a double seal structure for sealing against the front roof 3. The molded part 8 is also connected at the other end to an extrusion 17 providing sealing against the window glass 7. A fitting 9 having an open top is formed in the corner of the molded part 8. In FIG. 2, triangles are used to indicate that the filled side is the molded part and the non-filled side is the extrusion. This also applies to other figures.

On the other side, the roof side weatherstrip 6 has a molded part 12 integrally formed at the rear end with an insert 11. The molded part 12 is fit into the fitting 9 when the front roof 3 is mounted from above, contacting the weatherstrip 5 and roof side weather strip 6 together for sealing. FIGS. 3 and 4 are cross-sectional views of the molded part 8 at the sections A-A and B-B in FIG. 2, respectively, after the molded part 12 is fit into the fitting 9. In the FIG. 3, the number 14 represents a metal insert.

The rear roof 2 and front roof 3 of the convertible car shown in FIG. 1 are automatically opened/closed as follows. In one way, a motor-driven actuator (not shown) is provided to separately turn the rear roof 2 and front roof 3; in the roof-closing operation, the front roof is closed first and then the rear roof is closed. In another way, an actuator for turning the rear roof and an actuator for turning and elevating/lowering the front roof are provided; in the roof-closing operation, the rear roof is closed first and then the front roof is closed by turning it over the rear roof and lowering it. In yet another way, an actuator for turning the rear roof and an actuator for moving the front roof between a stored position and a closed position such as a link mechanism are provided; in the roof-closing operation, the rear roof is closed first and then the front roof is moved from the stored position to the closed position over the rear roof.

In the first case where the front roof is closed first, the fitting 9 of the molded part 8 and the insert 11 of the molded part 12 of the prior art structure as shown in FIG. 2 have the problem that the bottom edge 9a of the fitting 9 makes contact with the end face of the insert 11 and, consequently, the bottom edge 9a of the fitting 9 is turned outside or the insert 11 goes under the fitting 9, impairing the seal. In order to resolve this problem, fitting 9 can be made larger in depth or the insert 11 can be faced upward so that the bottom edge of the fitting does not interfere with the end face of the insert. However, such modifications create a gap between the insert 11 and the fitting 9 when they are fit together, impairing the seal.

In the last two cases where the rear roof is closed first and then the front roof is closed either by turning it over the rear roof and lowering it or by moving it from the stored position to the closed position over the rear roof, the insert 11 makes contact with the top edge 9b of the fitting 9 and the top edge 9b is pushed in and rolled when they are fit together, impairing the seal. In order to resolve this problem, the top edge 9b is set back downward in FIGS. 2 and 4 to enlarge the top opening of the fitting 9, thereby preventing interference with the insert 11. Such modification creates a gap between the insert 11 and the fitting 9 when they are fit together, impairing the seal.

The purpose of the present invention is to resolve the above problems when automatically opening/closing the front and rear roofs. The first purpose of the present invention is to provide a seal structure that prevents the bottom edge of the fitting from rolling and the insert from going under the fitting, which otherwise occurs when the bottom edge of the fitting makes contact with the end face of the insert after the front roof is closed first, preventing the impairment of the seal.

The second purpose is to provide a seal structure that prevents the top edge of the fitting from being pushed in and rolled as a result of interference between the top edge of the fitting and the insert after the rear roof is closed first, thereby preventing impairment of the seal.

Other purposes of this invention will appear in the ensuring specification, drawings and claims.

### SUMMARY OF THE INVENTION

The present invention relates to a seal structure for a convertible car having front and rear roofs separately turned and opened/closed by means of a motor-driven actuator wherein the front roof is closed first and then the rear roof is closed in the roof-closing operation. More specifically, the present invention relates to a seal structure consisting of a roof side weatherstrip attached to the roof side of the front roof to provide a seal against the window glass and an open weather strip attached to the front edge of the rear roof to provide a seal against the front roof and window glass wherein the molded part of the open weatherstrip that is attached to the corners of the rear roof is contacted to the end of the roof side weatherstrip for sealing. A contacted surface tilted or curved upward in the back is formed at the rear end of the roof side weatherstrip and a contacting surface tilted or curved downward in the front is formed at the molded part of the open weatherstrip. When the front roof is closed and then the rear roof is closed, the contacting surface of the open weatherstrip is pressed against and contacted to the contacted surface of the roof weatherstrip from the side.

The convertible car relating to the present invention has a back window, which can be integrated with the rear roof so that they are opened/closed together or so that the back window can be opened/closed separate from the rear roof.

Preferably, at least one of the contacting and contacted surfaces has an anti-rolling means for preventing the [symbol] of the contacted surface from being rolled downward when the contacting surface is pressed against the contacted surface.

Another invention relates to a seal structure for a convertible car having front and rear roofs separately opened/closed by means of a motor-driven actuator wherein the rear roof is closed first and then the front roof is closed over the rear roof in the roof-closing operation. More specifically, the invention relates to a seal structure consisting of a roof side weatherstrip attached to the roof side of the front roof to provide a seal against the window glass and an open weatherstrip attached to the front edge of the rear roof to provide a seal against the front roof and window glass wherein the molded part of the open weatherstrip that is attached to the corners of the rear roof is contacted to the end of the roof side weather strip. A contacted surface tilted or curved upward in the back is formed at the rear end of the roof side weatherstrip and a contacting surface tilted and curved downward in the front and having a larger width than the contacted surface at least in the upper part is formed at the molded part of the open weather strip. When the rear roof is closed and then the front roof is closed, the contacted surface at the end of the roof side weatherstrip is pressed against and contacted to the contacting surface of the open weatherstrip from above.

### BRIEF DESCRIPTION OF THE DRAWINGS

FIG. 1 is a perspective view of the core part of a convertible car showing an open weatherstrip and a roof side weatherstrip;

FIG. 2 is a perspective view of the molded parts of the prior art seal structure in the part a of FIG. 1;

FIG. 3 is a cross-sectional view at the section A-A in FIG. 2 showing the molded parts contacted together in the prior art seal structure;

FIG. 4 is a cross-sectional view at the section B-B in FIG. 2 showing the molded parts contacted together in the prior art seal structure;

FIG. 5 is a perspective view of the molded parts of the seal structure according to the present invention in part a of FIG. 1;

FIG. 6 is a perspective view of the seal structure according to the present invention showing the molded parts contacted together after the rear roof is closed.

FIG. 7 is a cross-sectional view at the section C-C in FIG. 6;

FIG. 8 is a cross-sectional view at the section D-D in FIG. 6; and

FIG. 9 is an illustration showing another form of the anti-rolling means.

### DESCRIPTION OF THE PREFERRED EMBODIMENT

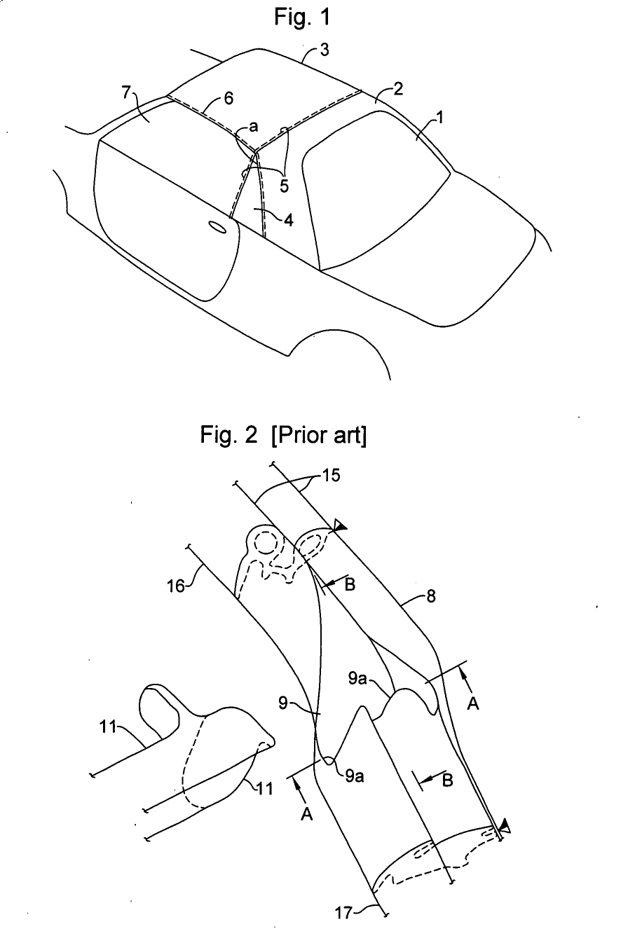

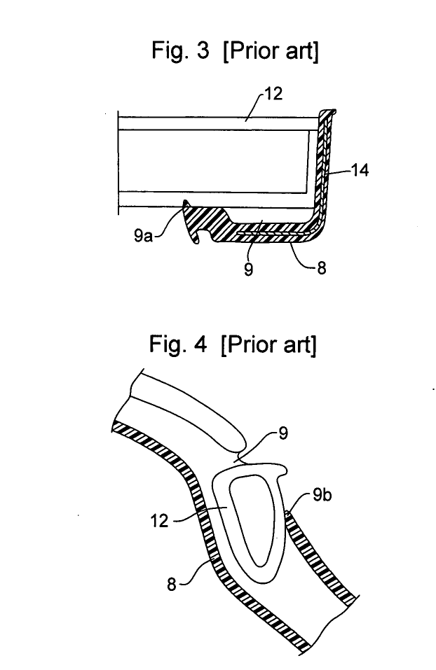

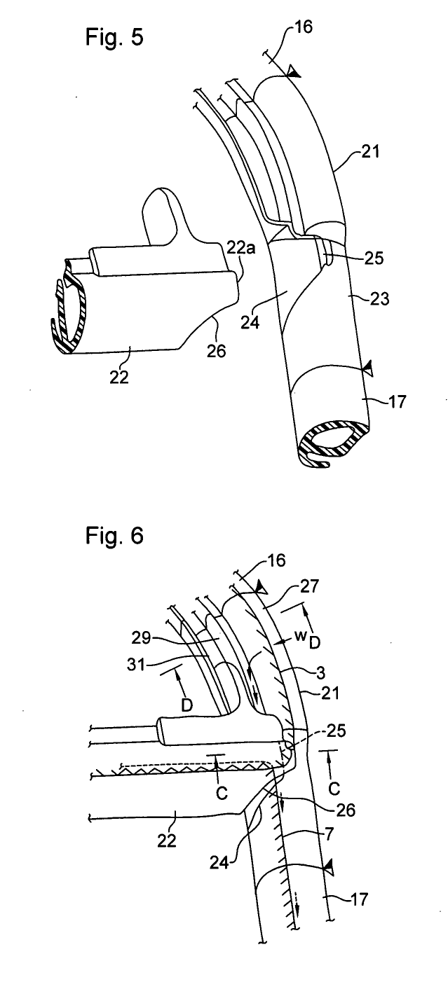

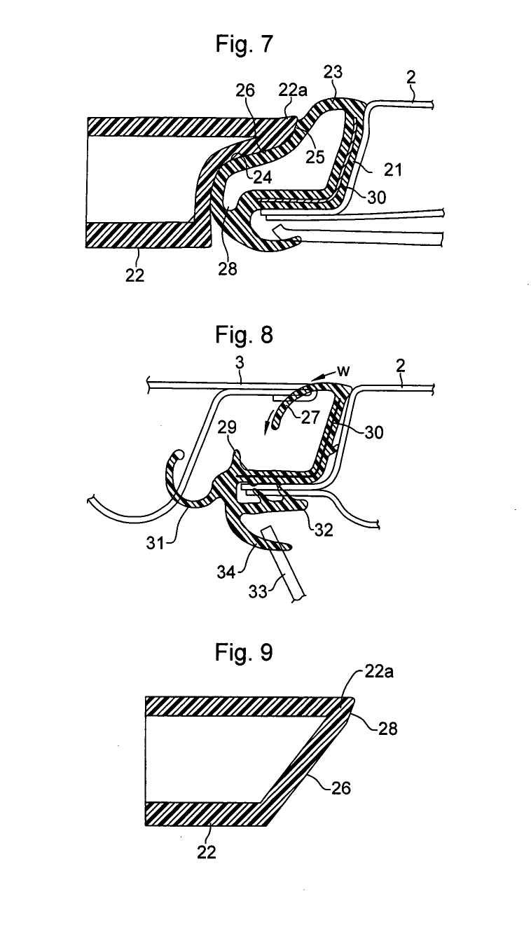

FIG. 5 shows a molded part 21 of the open weatherstrip 5 that is attached to a corner of the rear roof 2 in part a of FIG. 1 and a molded part 22 formed at the rear end of the roof side weatherstrip 6 attached to the roof side of the front roof 3 and forming the seal structure together with the open weatherstrip 5. FIG. 6 shows the molded parts 21 and 22 contacted together after the front roof 3 and rear roof 2 are closed. FIGS. 7 and 8 are cross-sectional views at the sections C-C and D-D in FIG. 6, respectively.

The molded part 21 is formed in place of the prior art molded part 8 shown in FIG. 2. The molded part 22 is formed in place of the prior art molded part 11 also shown in FIG. 2. The molded part 21 has a bulb part 23 with an insert metal 30. The bulb part 23 has on the front side facing the molded part 22 a contacting surface 24 curved downward in the front and a protrusion 25 as an anti-rolling means above the contacting surface 24. On the other hand, the molded part 22 has at the end a contacted surface 26 curved upward in the back. The rear roof 2 and front roof 3 are supported by the convertible car body so that they are each turned. They are separately turned between the stored position and the closed position shown in FIG. 1 by means of an un-shown known motor-driven actuator provided on this kind of convertible car. The front roof 3 is closed first and then the rear roof 2 is closed in the roof-closing operation. In this way, the contacting surface 24 of the molded part 21 of the open weatherstrip 5 makes contact with and is pressed against the contacted surface 26 at the end of the roof side weather strip from the side for sealing. In making contact, the protrusion 25 first makes contact with the [symbol] 22a of the contacted surface 26 and pushes it upward. Pushing further, the contacting surface 24 makes area-contact with and is pressed against the contacted surface 26. Therefore, instances in which only the [symbol] 22a is in contact with the contacting surface 24 or the [symbol] 22a is pushed in and rolled downward or upward are prevented.

In the state of FIG. 6 where the contacting surface 24 and contacted surface 26 are contacted together after the roofs 2 and 3 are closed, a lip 29 or 31 shown in FIG. 8 allows no water to enter the inside of the car even if water enters between a sub-seal 27 and the front roof 3. The water is discharged after running along the lip 29 in the bulb part 23 and a drain 28 in the arrowed direction of FIG. 6 and down through the door panel in the direction shown by the arrowed dotted lines. In FIG. 8, number 31 represents a main seal; number 32, a grip part; number 33, interior trim; and number 34, a decorative lip covering the interior trim 33.

In another embodiment, a motor-driven actuator for turning the rear roof to the stored position or the closed position shown in FIG. 2 and a turning device and lifting device such as an air cylinder for turning and elevating/lowering the front roof are provided, and an actuator for turning and elevating/lowering the front roof so as to switch to the stored position or the closed position shown in FIG. 2 is provided. In the roof-closing operation, the rear roof 2 is closed first and then the front roof 3 is closed by turning it over the rear roof and lowering it. In this way, the contacted surface 26 at the end of the roof side weatherstrip makes contact with the contacting surface 24 of the molded part 21 of the open weatherstrip 5 from above and then is pressed down for sealing. The actuator for switching the rear roof to the stored position or the closed position and the actuator for turning and elevating/lowering the front roof so as to switch to the stored position or the closed position are not shown in the figures. These actuators can be known actuators provided on this kind of convertible car.

In yet another embodiment, an actuator for example consisting of a link mechanism is provided for moving the front roof of the above described embodiments between the stored position and the closed position over the rear roof. In the roof-closing operation, the rear roof is closed first and then the front roof 3 is closed by moving it over the rear roof, by which the contacted surface 26 makes contact with the contacting surface 24 from above for sealing as in the above described embodiments.

In the above described embodiments, the anti-rolling means 25 is a protrusion 25. In another embodiment, the anti-rolling means is a guide surface 28 formed upward at the [symbol] 22a of the contacted surface 26 as shown in FIG. 9. The guide surface 28 makes it difficult for the [symbol] 22a of the contacted surface to make contact with the contacting surface 24 when the rear roof is closed. Even if the contact is made, it is difficult to roll the [symbol] 22a because of increased rigidity.

While a preferred embodiment has been described, variations thereto will occur to those skilled in the art without departing from the spirit or scope of the following claims.

What is claimed is:

1. A seal structure for a convertible car having front and rear roofs separately turned and opened/closed wherein the front roof is closed first and then the rear roof is closed in the roof-closing operation, comprising:
a roof side weatherstrip attached to the roof side of said front roof to provide sealing against the window glass; and
an open weatherstrip attached to the front edge of said rear roof to provide sealing against the front roof and window glass, wherein
a contacted surface tilted or curved upward in the back is formed at the rear end of said roof side weatherstrip; and
a contacting surface tilted or curved downward in the front and pressed against and contacted to said contacted surface at the rear end of said roof side weatherstrip from the side when said front roof is closed and then said rear roof is closed is formed at the molded part of said open weatherstrip that is attached to the corners of the rear roof.

2. The seal structure according to claim 1 wherein at least one of said contacting and contacted surfaces has an anti-rolling means for preventing the [symbol] of said contacted surface from being rolled down when said contacting surface is pressed against said contacted surface.

3. A seal structure for a convertible car having front and rear roofs separately opened/closed wherein the rear roof is closed first and then said front roof is closed over the rear roof in the roof-closing operation, comprising:
a roof side weatherstrip attached to the roof side of said front roof to provide sealing against the window glass; and
an open weatherstrip attached to the front edge of said rear roof to provide sealing against the front roof and window glass; wherein
a contacted surface tilted or curved upward in the back is formed at the rear end of said roof side weatherstrip;
a contacting surface tilted or curved downward in the front, having a larger width than said contacted surface at least in the upper part, and pressed by and contacted to said contacted surface at the rear end of said roof side weatherstrip from above when the rear roof is closed and then the front roof is closed is formed at the molded part of said open weatherstrip that is attached to the corners of the rear roof.
